(19) United States
(12) Patent Application Publication
(10) Pub. No.: US 2002/0128041 A1
(43) Pub. Date: Sep. 12, 2002

(54) Methods and systems for controlling multiple computing devices

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/802,665

(22) Filed: Mar. 9, 2001

(51) Int. Cl. H04M 1/00

(52) U.S. Cl. 455/560; 455/88; 455/419; 455/420

(57) ABSTRACT

Systems and methods for controlling multiple computing devices are described. In one embodiment, a switching device comprises a wireless transmitter and a wireless receiver. The receiver is configured to receive data from a user so that a wireless link can be established with one of multiple computing devices that can be selected by the user. The transmitter is configured to wirelessly transmit data to the computing devices, and the receiver is configured to receive wirelessly transmitted data from the computing devices thus permitting the user to interact with and control the computing devices. In another embodiment, a computing system comprises multiple computing devices, each of which being configured for wireless communication. A switching device is configured to wirelessly receive and transmit data. One or more peripheral devices are provided and are configured to wirelessly receive and transmit data. The switching device is configured to enable a user to select from among the multiple computing devices and wirelessly link a peripheral device with a selected computing device to enable wireless user interaction.

### TECHNICAL FIELD

This invention relates to methods and systems for controlling multiple computing devices.

### BACKGROUND

FIG. 1 shows a typical computing environment generally at 100 that includes multiple different computers 102, 104, and 106. Each computer typically comes equipped with some type of user input device or peripheral device. In this example, each computer includes a keyboard, mouse and a monitor. Users enter information into the computer via the keyboard and mouse, and, can generally view displays for interacting with the computer on the monitor. Such displays include graphic user interfaces or “GUIs” as they are sometimes called. In this model, each computer is its own standalone device. These individual standalone computers may have their own specific functionalities that are different from the functionalities provided on the other computers.

For example, assume that the illustrated computers comprise part of an enterprise computing system for a business. Computer 102 may contain a collection of software applications that are used to accomplish accounting tasks. Computer 104 may contain a software application that can be used to organize and manage human resource statistics for an organization. If the user of computer 102 wishes to work with the organization's human resource statistics, they must typically use computer 104. This can involve logging off of computer 102, and physically moving to the location of and logging onto computer 104. Needless to say, this is an inefficient solution.

FIG. 2 shows a computing system 200 that attempts to improve upon the FIG. 1 model. In this example, a switching device 202 is provided and enables computers 204 and 206 to be controlled from a single keyboard, mouse or monitor. In this example, a number of different cables are connected between the switch 202 and both the computers 204, 206 and the user input devices. Exemplary cables are shown at 208, 210, 212, 214, and 216.

Switches of this type are sold by a company named Belkin, and are designated as “KVM OmniView™” switches. Using these types of switches, users can select a particular computer by physically switching the switch to an appropriate selection. For example, in this illustration, computer 204 is designated as computer “A” and computer 206 is designated as computer “B”. If a user is working on computer A and desires to work on computer B, they would simply engage switch 202 and change the selection from A to B. While this is a convenient way to provide flexible computing solutions to users, it falls short of providing a truly robust, flexible, extensible, and easily adaptable solution.

Consider, for example, the robustness of the FIG. 2 solution. In the FIG. 2 system, each computer that is desired to be controlled must be hardwired with one cable that extends between it and the switch. Similarly, each peripheral device that is desired to be used to control a computer must also be hardwired with one cable that extends between it and the switch. The larger the number of either computers or peripheral devices, the larger the number of cables that are necessary for making an adequate connection. Because the ports on the switch that receive the cables take up physical space, there is a practical size limit beyond which the switch's form factor or footprint becomes unwieldy. Realistically then, switches accommodating up to about four or eight computers reach a practical size limit. Accordingly, this system is not robust.

The FIG. 2 system is also inflexible, is not conveniently extensible (if at all), and is not conveniently adaptable for the following reasons. If one wishes to change the arrangement of computers that are connected to switch 202 by, for example, adding a new computer, a new cable must be run from the new computer to the switch. Consider the situation where the new computer is located in a room that is different from the room in which the switch is located. A new cable must be physically installed and run, by hand, between the new computer and the switch. This is not a flexible or convenient solution.

Additionally, because of the practical size limits on the switch as mentioned above, it can become impracticable or, in some cases, impossible to incorporate a large number of computers for use with the switch. The impracticability stems from concerns associated with the ultimate footprint of the switch (i.e. is it really practicable to hardwire 20 computers to a switch so that they can be accessed by 20 different users?). The impossibility stems from the physical limitations of the switch itself. Specifically, if the switch is configured with ports that physically accommodate only two computers and three peripheral devices, then there is no way that one could connect three computers and two sets of three peripheral devices. Accordingly, the FIG. 2 solution lacks a desired degree of flexibility, extensibility, and adaptability.

Accordingly, this invention arose out of concerns associated with providing improved systems, devices and methods for providing users with the ability to control multiple computing devices.

### SUMMARY

Systems and methods for controlling multiple computing devices are described. In one embodiment, a switching device comprises a wireless transmitter and a wireless receiver. The receiver is configured to receive data from a user so that a wireless link can be established with one of multiple computing devices that can be selected by the user. The transmitter is configured to wirelessly transmit data to the computing devices, and the receiver is configured to receive wirelessly transmitted data from the computing devices thus permitting the user to interact with and control the computing devices.

In another embodiment, a computing system comprises multiple computing devices, each of which being configured for wireless communication. A switching device is configured to wirelessly receive and transmit data. One or more peripheral devices are provided and are configured to wirelessly receive and transmit data. The switching device is configured to enable a user to select from among the multiple computing devices and wirelessly link a peripheral device with a selected computing device to enable wireless user interaction.

In yet another embodiment, a computing system comprises multiple computing devices, each of which being configured for wireless communication. A switching device is configured to wirelessly receive and transmit data, and one or more peripheral devices are provided and are linkable with the computing devices for data exchange. The switching device is configured to enable a user to select from among the multiple computing devices and wirelessly link itself with a selected computing device to enable user interaction with the computing device.

In a further embodiment, a method for controlling multiple computing devices comprises receiving data from a user. The data is associated with a user selection of one of multiple computing devices with which a user can interact. The received data is used to select a computing device, and a wireless link is established with the computing device. The wireless link permits the user to interact with the computing device.

### BRIEF DESCRIPTION OF THE DRAWINGS

The same numbers are used throughout the drawings to reference like features and components.

FIG. 1 is a system diagram of an existing computing model.

FIG. 2 is a system diagram of another existing computing model.

FIG. 3 is a block diagram that shows various components of a switching device in accordance with one embodiment.

FIG. 4 is a flow diagram that describes steps in a method in accordance with one embodiment.

FIG. 5 is a system diagram that illustrates an exemplary computing model that can be enabled by the inventive switching device.

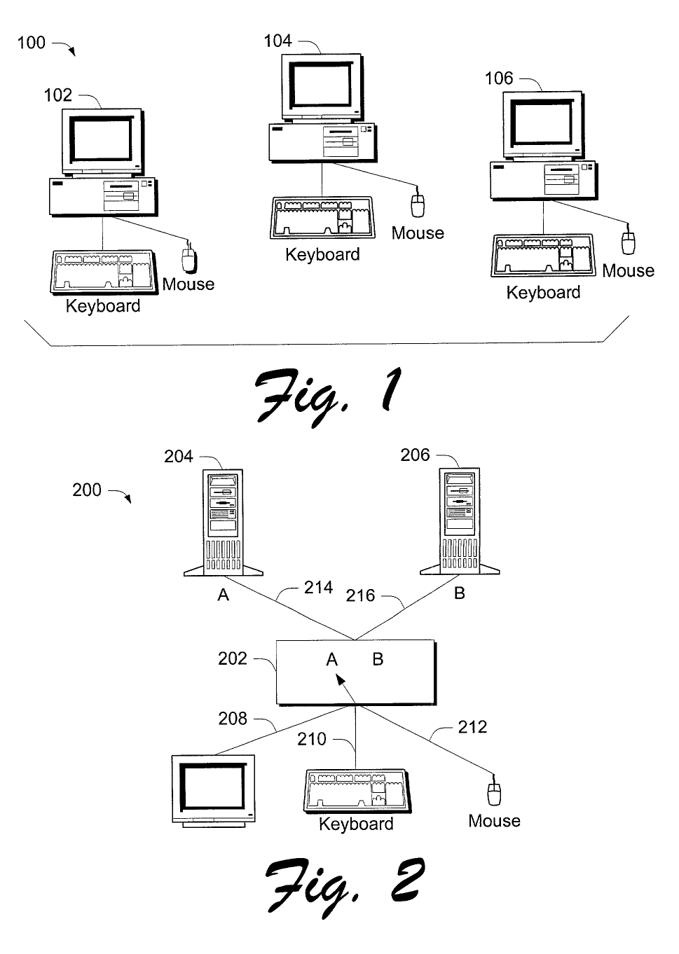

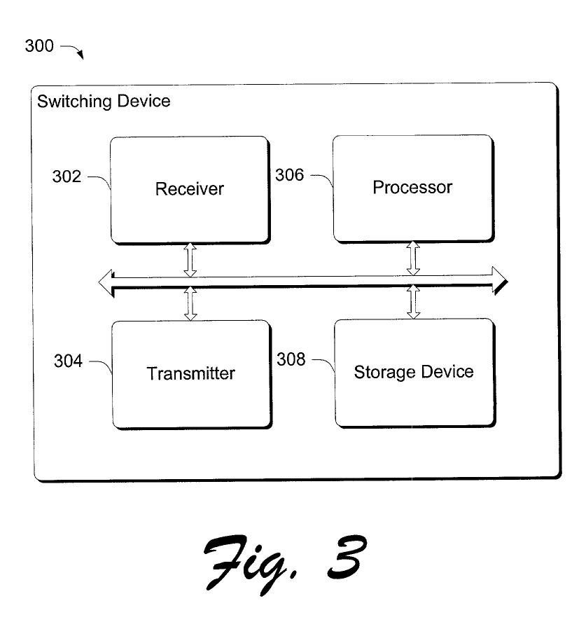

### DETAILED DESCRIPTION

Overview

Methods and systems for controlling multiple different computing devices are described. Convenience and flexibility are achieved through a switching device that permits wireless links to be established with multiple different computing devices so that a user can interact with and control the computing devices via one or more computer peripheral devices. In addition, the switching device can permit a user to establish a wireless link between one or more peripheral devices and the switching device. Cable-based connections can, in some instances, be completely eliminated.

Exemplary Embodiment

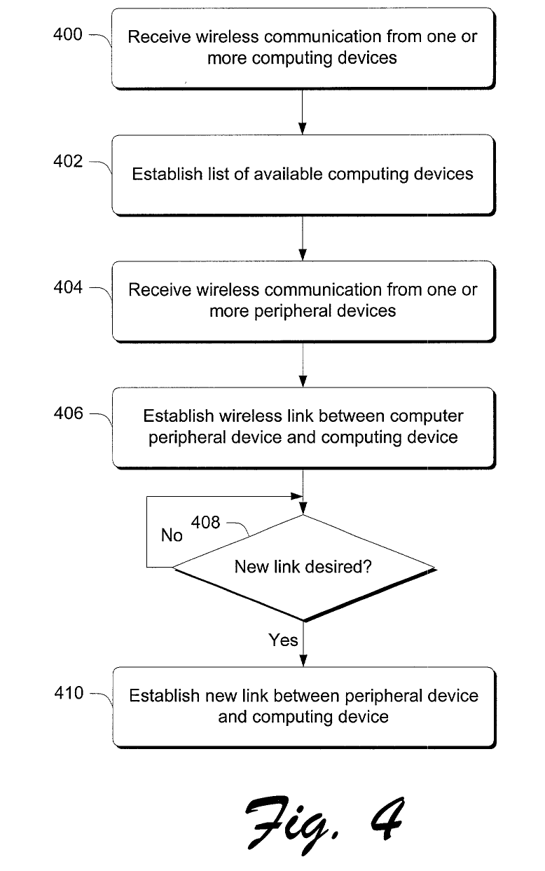

FIG. 3 shows an exemplary switching device in accordance with one embodiment, generally at 300. Switching device 300 is advantageously configured for wireless communication so that it can wirelessly receive and transmit data. The switching device can be used to establish a wireless link between one or more user peripherals (i.e. a keyboard, mouse or display device) and multiple computing devices so that a user can, through the switching device, control or otherwise interact with the computing devices.

In the illustrated example, switching device 300 comprises a receiver 302 and transmitter 304. Any suitable receiver and transmitter can be used. In addition, any suitable wireless protocols can be used in connection with the receiver and transmitter. For example, the receiver and transmitter can be enabled with BlueTooth or 802.11b protocols. In addition, though the transmitter and receiver are depicted as individual units, it is to be appreciated and understood that the transmitter and receiver could be an integrated unit such as a transceiver. Exemplary receivers and transmitters and the principles under which they operate are described in the following U.S. Patents, the disclosures of which are incorporated by reference herein: U.S. Pat. Nos. 6,175,860; 6,174,205; 6,151,645; and 6,137,473.

In addition to the receiver and transmitter, switching device 300 includes a processor 306 that can be any suitable processor or microprocessor. Typically, the processor is programmed to function by way of computer-readable instructions that can be embodied on a computer-readable medium. To this extent, the claimed subject matter includes such computer-readable media when such contains instructions for implementing the functionality described above and below. The switching device also includes one or more storage devices 308. These devices can be embodied in any form of medium that can store data. Examples include RAM, ROM, Flash memory, magnetic disks and the like.

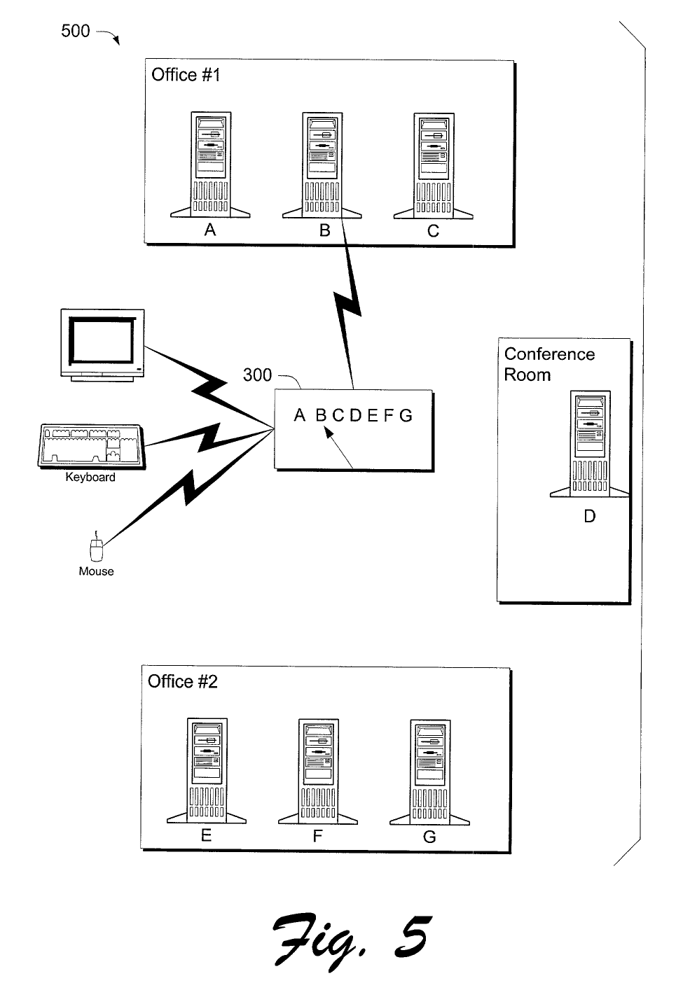

FIG. 4 is a flow diagram that describes steps in a method in accordance with one described embodiment. The method can be implemented in any suitable hardware, software, firmware, or combination thereof. In the illustrated example, the method is implemented by a switching device, such as the one described in connection with FIG. 3.

Step 400 receives wireless communication from one or more computing devices. The communication can establish an initial link with the switching device so that the switching device can identify the computing device and perhaps assign an identity to it for future reference. Such identity can be stored on the switching device on, for example, a storage device. In the illustrated and described embodiment, the switching device can receive wireless communication from any suitable number of computing devices. Such number need not be a fixed number. Specifically, in the prior switching devices, recall that the number of computing devices that could be linked with a switching device was limited by the number of ports provided on the device. In the present case, such need not be the case. Specifically, in some switching devices external “plug in” ports are not necessary. Thus, there is no physical space limitation imposed on the switching device. In other switching devices having physical ports, wireless cap structures can be used and inserted into the port for facilitating wireless communication. The cap structure can include a receiver and a transmitter for receiving and transmitting wireless communication or data.

Step 402 establishes a list of available computing devices. This step can be implemented in the form of a list that is maintained by the switching device. For example, as the computing devices report in to the switching device, the switching devices notes the device and places it on a list. Alternately, the list can be pre-established by a user. For example, the user can simply designate the computing devices that are to be wirelessly linked. Step 404 receives wireless communication from one or more computer peripherals, and step 406 establishes a wireless link between the computer peripheral and a computing device. The wireless communication that is received can thus enable a user to interact with the computing device. Step 408 ascertains whether a new link is desired with a different computing device is desired. This step is implemented by the user selecting a different computing device. If no link is desired, the current link can be maintained or, if desired by the user, terminated. If, however, step 408 determines that a new link is desired, then step 410 establishes a new link between the computer peripheral and the computing device.

The method described above advantageously enables a user to wirelessly establish a link with any number of suitable computing devices. Once the link is established, the user can then interact with or control the computing device using a computer peripheral such as a keyboard, mouse, and/or display. By virtue of its wireless nature, the method and system described above does away with unwieldy cables. This results in a system that is much easier to use. In addition, new computing devices can be quickly added to and incorporated for use with the system. Recall that in the prior cable-based system, the new computing device required a physical cable to be plugged into it and run to the switching device. In the present case, the new computing device is simply noted in, for example, a list that is maintained by the switching device and then incorporated into the system. As far as extensibility, the present embodiment is much quicker and more convenient to use.

Exemplary Implementation

FIG. 5 shows one exemplary implementation in which a switching device 300 is used to establish wireless communication between multiple different computer peripherals and many different computing devices. In this particular example, the computing devices are desk top computers.

In this example, seven computers are provided and are designated A through G. Computers A-C are located in a first office, computer D is located in a conference room, and computers E-G are located in a second office. Switching device 300 can be located in any suitable location. In this particular example, the user has selected computer B for establishing a wireless link. Once the link is established, the user can then interact with or otherwise control the computer. After working for a time on computer B, the user might then decide that they need to access computer F in the second office. To do this, they would simply make their selection on the switching device and then begin to interact with computer F.

Conclusion

The described systems and methods provide much more flexibility and convenience than previous solutions, for users who desire to control or interact with multiple different computers.

Although the invention has been described in language specific to structural features and/or methodological steps, it is to be understood that the invention defined in the appended claims is not necessarily limited to the specific features or steps described. Rather, the specific features and steps are disclosed as preferred formed of implementing the claimed invention.

I claim:

1. A switching device comprising:
a wireless transmitter; and
a wireless receiver associated with the wireless transmitter;
the receiver being configured to receive data from a user so that a wireless link can be established with one of multiple computing devices that can be selected by the user;
the transmitter being configured to wirelessly transmit data to the computing devices, the receiver being configured to receive wirelessly transmitted data from the computing devices to permit the user to interact with and control the computing devices.

2. The switching device of claim 1, wherein the transmitter and receiver are configured to establish a wireless link with at least one peripheral device that can be used by a user to interact with the computing device.

3. The switching device of claim 2, wherein said at least one peripheral device comprises a keyboard.

4. The switching device of claim 2, wherein said at least one peripheral device comprises a mouse.

5. The switching device of claim 2, wherein said at least one peripheral device comprises a display.

6. The switching device of claim 2, wherein said at least one peripheral device comprises one or more of a keyboard, a mouse and a display.

7. The switching device of claim 1, wherein the transmitter and receiver are configured to establish a wireless link via BlueTooth.

8. The switching device of claim 1, wherein the transmitter and receiver comprise an integrated unit.

9. The switching device of claim 1 further comprising a storage device to store data associated with the multiple computing devices and which can be used to establish said wireless link.

10. A computing system comprising:
multiple computing devices, each of which being configured for wireless communication;
a switching device configured to wirelessly receive and transmit data; and
one or more peripheral devices configured to wirelessly receive and transmit data;
the switching device being configured to enable a user to select from among the multiple computing devices and wirelessly link a peripheral device with a selected computing device to enable wireless user interaction.

11. The computing system of claim 10, wherein the computing devices comprise desktop computers.

12. The computing system of claim 10, wherein at least one of the peripheral devices comprises a keyboard.

13. The computing system of claim 10, wherein at least one of the peripheral devices comprises a mouse.

14. The computing system of claim 10, wherein at least one of the peripheral devices comprises a display.

15. The computing system of claim 10, wherein at least one of the peripheral devices comprises a keyboard, mouse or display.

16. A computing system comprising:
multiple computing devices, each of which being configured for wireless commumcation;
a switching device configured to wirelessly receive and transmit data;
one or more peripheral devices linkable with the computing devices for data exchange; and
the switching device being configured to enable a user to select from among the multiple computing devices and wirelessly link itself with a selected computing device to enable user interaction with the computing device.

17. The computing device of claim 16, wherein the computing devices comprise desktop computers.

18. The computing device of claim 16, wherein at least one of the peripheral devices comprises a keyboard.

19. The computing device of claim 16, wherein at least one of the peripheral devices comprises a mouse.

20. The computing device of claim 16, wherein at least one of the peripheral devices comprises a display.

21. A method of controlling multiple computing devices comprising:
receiving data from a user, the data being associated with a user selection of one of multiple computing devices with which a user can interact;
using the received data to select said one computing device;
establishing a wireless link with said one computing device; and
permitting the user to interact with said one computing device via said wireless link.

22. The method of claim 21, wherein said receiving comprises wirelessly receiving said data from the user.

23. The method of claim 21, wherein said permitting comprises wirelessly receiving data from a peripheral device comprising one or more of: a keyboard, a mouse and a display.

24. The method of claim 21, wherein said establishing of the wireless link comprises establishing a wireless link with a desktop computer.

25. One or more readable media having instructions thereon which, when executed by a switching device, cause the switching device to:
wirelessly receive data from a user, the data being associated with a user selection of one of multiple computing devices with which a user can interact;
use the received data to select said one computing device;
establish a wireless link with said one computing device; and
permit the user to interact with said one computing device via said wireless link.
